(19) United States
(12) Patent Application Publication
(10) Pub. No.: US 2011/0123681 A1
(43) Pub. Date: May 26, 2011

(54) DOUGH PRODUCT INCLUDING LAMINATED AND NON-LAMINATED DOUGH COMPONENTS

(76) Inventors: J. Kofi A. Mensah, Mounds View, MN (US); Stephen M. Jacobsen, Coon Rapids, MN (US)

(21) Appl. No.: 12/950,316

(22) Filed: Nov. 19, 2010

Related U.S. Application Data
(60) Provisional application No. 61/263,008, filed on Nov. 20, 2009.

(51) Int. Cl. A21D 13/08; A21D 8/00; A23P 1/08

(52) U.S. Cl. 426/94; 426/502; 426/297

(57) ABSTRACT

A composite dough product including a laminated dough component and a non-laminated dough component is described. The laminated dough component includes at least one layer of fat, such as a layer of roll-in shortening, and at least one layer of dough. The thickness of the non-laminated dough component is greater than the thickness of a layer of dough in the laminated dough component. Alternatively, the weight of the non-laminated dough component is greater than the weight of a layer of dough in the laminate. The laminated dough component and the non-laminated dough component each retain their individual characteristics in the composite dough product.

### TECHNICAL FIELD

The invention relates to a composite dough product including both a laminated dough component and a non-laminated dough component, wherein the laminated dough component and the non-laminated dough component each retain their individual characteristics in the composite dough product.

### BACKGROUND

Laminated dough products, such as Danish pastries, biscuits, rolls, croissants, puff pastry, sweet rolls, toaster pastries, and medialunas, are made from laminated doughs containing layers of fat interspersed between layers of dough. These products depend on the layers of fat, such as layers of butter or shortening, to provide a flaky, crisp texture at the surface of the cooked products, as well as a honeycomb appearance and tender texture in the interior of the cooked products.

Laminated dough products are made by distributing discrete layers of fat throughout the entire dough. Examples of laminated dough products are described in U.S. Pat. Nos. 4,612,198 and 4,623,542, the teachings of which are incorporated by reference in their entirety herein. These patents are directed to breakfast pastries made from laminated doughs including layers of roll-in shortening distributed throughout the doughs.

### SUMMARY

It has been discovered that by strategically placing layers of fat, such as roll-in shortening, in locations in a dough product where the functionality of the fat layers is maximized, the resulting composite dough product can have the desired organoleptic properties of a fully laminated dough product, but can be made with a lower amount of fat than a fully laminated dough product. A “composite dough product”, as used herein, refers to a dough product which includes a “laminated dough” component and a “non-laminated dough” component. As used herein, “laminated dough” refers to a dough including at least one laminate, and a “laminate” refers to at least one discrete layer of fat and at least one layer of dough, in which the layer of fat and the layer of dough are adjacent to each other. Also as used herein, “non-laminated dough” refers to a dough that has not been laminated and that does not contain a discrete layer of fat. A “fully laminated dough product,” as used herein, is a non-composite dough product consisting of a plurality of laminates, and does not include a non-laminated dough component.

The invention is directed to a composite dough product including a laminated dough component, which includes at least one laminate, and a non-laminated dough component. The thickness of the non-laminated dough component is greater than the thickness of a layer of dough in a single laminate. Alternatively, the weight of the non-laminated dough component is greater than the weight of a layer of dough in a single laminate. The laminated dough component and the non-laminated dough component each retain their individual characteristics in the composite dough product, and these individual characteristics in the dough result in the desired organoleptic properties in the cooked product.

The invention is also directed to a composite dough product including at least one non-laminated dough component and at least two laminated dough components, or at least two non-laminated dough components and at least one laminated dough component, wherein each of the laminated dough components includes at least one laminate. The thickness of the non-laminated dough component is greater than the thickness of a layer of dough in a single laminate. Alternatively, the weight of the non-laminated dough component is greater than the weight of a layer of dough in a single laminate. The non-laminated dough component may be located between two laminated dough components or the laminated dough component may be located between two non-laminated dough components. Many other combinations of one or more non-laminated dough components and one or more laminated dough components are also possible and are within the scope of the invention. The laminated dough components and the non-laminated dough components each retain their individual characteristics in the composite dough product.

A composite dough product in accordance with the invention may have a lower percent fat content than a fully laminated dough product, while having organoleptic properties that are substantially identical or superior to the organoleptic properties of the fully laminated dough product. As used herein, the phrase “percent fat content” is defined to mean the percentage of fat in a product. The percent fat content may be calculated either as a weight percent or as a volume percent of the product.

The invention is further directed to a pastry product made from a composite dough product including at least one non-laminated dough component and at least one laminated dough component. The invention is also directed to a method of making a pastry product, including forming a laminated dough pad by laminating a first portion of a dough and a fat. A second non-laminated portion of the dough is then extruded onto the laminated dough pad. The weight of the second portion of the dough is greater than the weight of a single layer of dough in the laminate.

The foregoing has outlined rather broadly the features and technical advantages of the invention in order that the detailed description of the invention that follows may be better understood. Additional features of the invention which form the subject of the claims of the invention will be described hereinafter. It should be appreciated by those skilled in the art that the specific embodiments disclosed may be readily utilized as a basis for modifying or designing other structures for carrying out the same purposes of the invention. It should also be realized by those skilled in the art that such equivalent compositions do not depart from the spirit and scope of the invention as set forth in the appended claims. The novel features which are believed to be characteristic of the invention, both as to its composition, chemical functionality and process for making or using the composition, together with further objects and advantages will be better understood from the following description when considered in connection with the accompanying figures. It is to be expressly understood, however, that each of the figures is provided for the purpose of illustration and description only and is not intended as a definition of the limits of the invention.

### BRIEF DESCRIPTION OF THE DRAWINGS

FIG. 1 is a micrograph of a fully laminated control dough product, in which the entire dough is laminated.

FIG. 2 is a micrograph of an embodiment of a composite dough product, including a laminated dough component and a non-laminated dough component.

FIG. 3a is a micrograph of a second embodiment of a composite dough product, including a laminated dough component and a non-laminated dough component.

FIG. 3b is a micrograph of another embodiment a composite dough product, including a laminated dough component and a non-laminated dough component.

FIG. 4 depicts a cross-section of a dough product in which a laminated dough component is positioned between two non-laminated dough components.

FIG. 5 is a bar graph showing the percentages of fat in a fully laminated pastry product, a 35% laminated pastry product, and a 20% laminated pastry product.

FIG. 6a depicts a cross-section of a pastry product before the dough is folded to encase the filling. FIG. 6b depicts a cross-section of a pastry product after the dough is folded.

### DETAILED DESCRIPTION OF THE PREFERRED EMBODIMENTS

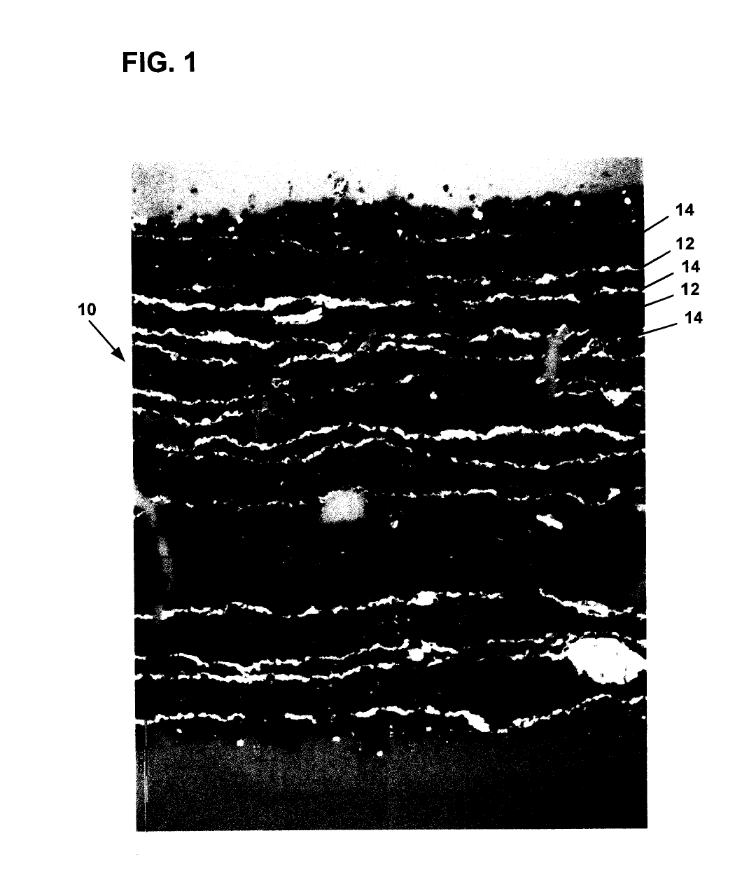

Fully laminated dough products include discrete layers of fat distributed throughout the dough. A micrograph of a control dough product, in which the entire dough is laminated, is shown in FIG. 1. The control dough product 10 includes a plurality of laminates. Each laminate includes at least one discrete layer of fat 12 and at least one layer of dough 14, wherein the layer of fat is adjacent to the layer of dough.

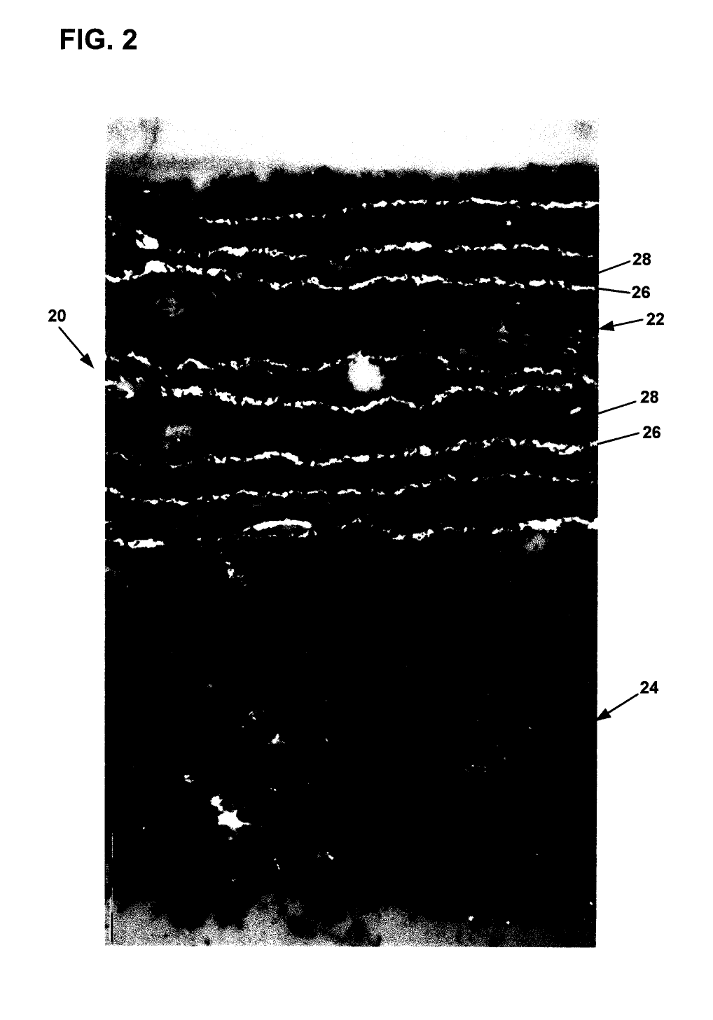

A micrograph of an embodiment of a composite dough product in accordance with the invention is shown in FIG. 2. The composite dough product 20 includes a laminated dough component 22, which includes a plurality of laminates, and a non-laminated dough component 24. Each laminate includes at least one discrete fat layer 26 and at least one dough layer 28, wherein the fat layer is adjacent to the dough layer. In this embodiment, the thickness of the laminated dough component 22 is approximately equal to the thickness of the non-laminated dough component 24.

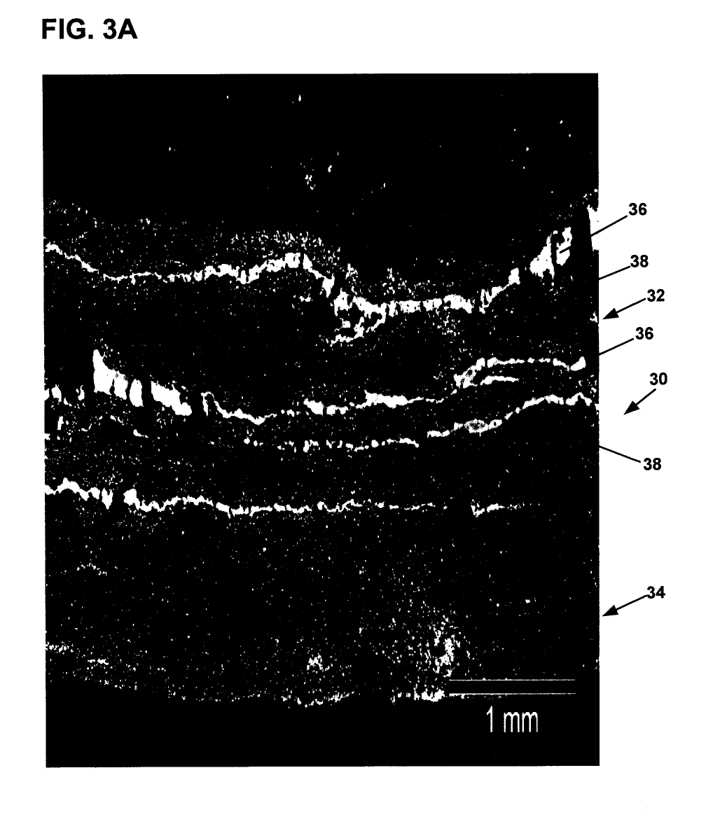

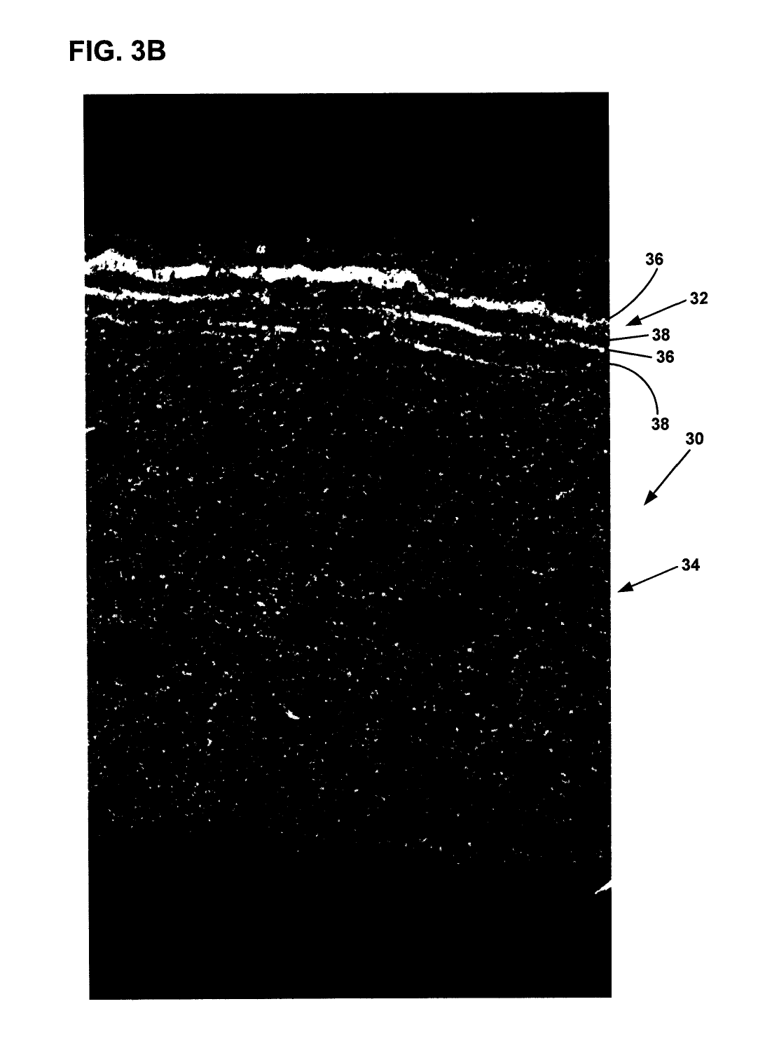

FIGS. 3a and 3b are micrographs of other embodiments of a composite dough product. In the embodiments shown, the composite dough product 30 includes a laminated dough component 32 and a non-laminated dough component 34. Each laminate of the laminated dough component 32 includes at least one discrete fat layer 36 and at least one dough layer 38, wherein the fat layer is adjacent to the dough layer. In FIG. 3a, the thickness of the non-laminated dough component 34 is less than the thickness of the laminated dough component 32, and laminated dough component 32 includes four fat layers 36. In FIG. 3b, the thickness of the non-laminated dough component 34 is greater than the thickness of the laminated dough component 32, and the laminated dough component 32 includes four fat layers 36.

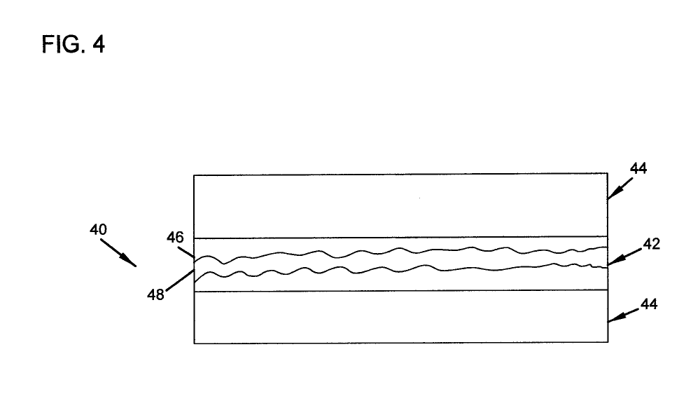

In the embodiments shown in FIGS. 2, 3a and 3b, the composite dough product includes one laminated dough component and one non-laminated dough component. However, a composite dough product in accordance with the invention may also include a plurality of laminated dough components and a plurality of non-laminated dough components. A composite dough component may also include one laminated dough component and a plurality of non-laminated dough components, or one non-laminated dough component and a plurality of laminated dough components. FIG. 4 depicts an embodiment of composite dough product 40 comprising one laminated dough component 42 and a plurality of non-laminated dough components 44. Specifically, this embodiment includes one laminated dough component 42 between two non-laminated dough components 44. The laminated dough component 42 includes a plurality of laminates, wherein each laminate includes at least one discrete fat layer 46 and at least one dough layer 48.

The laminated dough component may be prepared by placing a first layer of fat onto a first layer of dough, placing a second layer of dough onto the first fat layer, and continuing to place layers of fat on layers of dough, and layers of dough on layers of fat, until a laminated dough component with the desired number of layers is formed. The fat may be placed onto the dough using a variety of methods, such as by spraying, extruding, or depositing the fat onto the dough. The laminated dough component may also be prepared by placing fat onto a dough, folding and rolling out the dough so that one layer of fat is between two layers of dough, and then repeatedly folding and rolling out the fat layer-containing dough until a laminated dough component with the desired number of layers is formed. The preparation of the laminated dough component may also be accomplished by known and available machinery during one or more sheeting steps. Such typical machines may be a Rondo® sheeter, as well as others. In order to achieve the desired results of this invention, the layers of fat in the laminated dough component should be substantially discrete and continuous throughout the laminated dough component. As used herein, the term “discrete” shall be defined as being visible under a polarizing light microscope at 25× magnification. Any number of discrete layers of fat are contemplated, such as ranging from about 1 or 2 to any multiple of 4 layers, including about 1 to about 400 layers, or about 2 to about 200 layers, or about 2 to about 64 layers, or about 4 to about 36 layers.

The non-laminated dough component is the component of the composite dough product that does not contain discrete, continuous layers of fat in the dough. Therefore, the non-laminated dough component is substantially free of fat in the form of discrete and continuous fat layers. The non-laminated dough component may be a substantially continuous dough matrix, as opposed to a dough component comprising layers of dough interspersed with discrete layers of fat.

When a composite dough product is comprised of one or more laminated dough components and one or more non-laminated dough components, the thickness of any non-laminated dough component is greater than the thickness of any single layer of dough in a laminate of the laminated dough component.

The non-laminated dough component may have a thickness that is the same as or greater than the laminated dough component thickness. For example, the ratio of the non-laminated dough component thickness to the laminated dough component thickness may be about 9:1, 8:2, 7:3, or 6:4, or 1:1. Alternatively, the laminated dough component may have a thickness that is greater than the non-laminated dough component thickness. For example, the ratio of the laminated dough component thickness to the non-laminated dough component thickness may be about 9:1, 8:2, 7:3, 6:4, or 1:1. Other ratios of dough component thicknesses are contemplated by the invention.

Moreover, the weight of the non-laminated dough component may be the same as or greater than the total weight of the layers of dough in the laminated dough component. For example, the ratio of the non-laminated dough component weight to the weight of the layers of dough in the laminated dough component may be about 9:1, 8:2, 7:3, or 6:4, or 1:1. Alternatively, the total weight of the layers of dough in the laminated dough component may be greater than the non-laminated dough component weight. For example, the ratio of total weight of the layers of dough in the laminated dough component to the non-laminated dough component weight may be about 9:1, 8:2, 7:3, 6:4, or 1:1. Other ratios of dough component weights are contemplated by the invention.

The laminated dough component and the non-laminated dough component each retain their individual characteristics in the composite dough product. In general, after the composite dough product is cooked, the portion of the cooked product made with the laminated dough component has a crisp, flaky texture, while the portion of the cooked product made with the non-laminated component has a bready, tender, chewy or other desired texture. Therefore, upon cooking the composite dough product, the resulting product reflects the individual characteristics imparted by each dough component. These individual characteristics may include, for example, crust and crumb texture and visual appearance. As used herein, “cooking” includes: any means of thermally processing food products, such as with conduction, convection or radiation energy, for example, by baking, or frying; any means of volumetric electromagnetic heating such as ohmic, radio frequency or microwave heating; and any other means of processing a food product that results in the heating of molecules of the food product. As used herein, “cooked” products include any food products that have been processed by cooking.

The fat or lipid used to form the discrete layers of fat in the laminated dough component may include any fat or fat substitute that is able to form and retain substantially discrete and continuous fat layers in a dough product at room temperature. Such fats include shortening, margarine, butter, artificial fat, and the like having a melting point of at least about 45° C. As used herein, “lipid” refers to any fat-soluble (lipophilic) molecule, such as fats, oils, waxes, cholesterol, sterols, fat-soluble vitamins (such as vitamins A, D, E and K), monoglycerides, diglycerides, phospholipids, and others. Fats (which are also known as triglycerides) are one particular type of lipid, and include a wide group of compounds that are generally soluble in organic solvents and largely insoluble in water. In general from a chemical point of view, fats can be described as triesters of glycerol and fatty acids. Fats can be solid, liquid, or partially liquid at normal room temperature, depending on their structure and composition. As used herein, the term “laminate fat” shall be used to describe the fat used to form discrete fat layers in the dough.

One type of laminate fat that may be used is roll-in shortening. The type of roll-in shortening used is not critical. It may be any of the conventional hydrogenated vegetable oil shortenings available on the market that are commonly employed in the baking industry. Examples include plastic or hydrogenated glyceride shortenings derived most commonly from vegetable oils by hydrogenation. The common oils are cottonseed oil, soybean oil, coconut oil, rapeseed oil, peanut oil, olive oil, palm oil, sunflower seed oil and the like, and blends thereof. The laminate fat may be low trans-fat, zero trans-fat, or trans-fat free, or a combination thereof. One type of roll-in shortening useful in the invention may have a Mettler dropping point from about 48.5° C. to about 54.45° C., and may have a solid fat index or solid fat content at various temperatures within the ranges provided in Table 1, below. In one example of a toaster pastry product, roll-in shortening is included in the laminated dough component in an amount ranging from about 1% to about 20%, or from about 3% to about 18%, or from about 5% to about 15% by weight of the dough of the laminated dough component, or from about 7% to about 10% by weight of the dough of the laminated dough component.

TABLE 1
Solid Fat Index of Roll-in Shortening at Various Temperatures

| | Range of Solid | |
|---|---|---|
| | Fat Content | |
| | (SFC) or Solid | |
| Temperature | Fat Index (SFI) | Test Method |
| 10° C. | 41-78% (SFC) | AOCS CD 16B-93 |
| 20° C. | 35-62% (SFC) | AOCS CD 16B-93 |
| 30° C. | 32-39% (SFC) | AOCS CD 16B-93 |
| 40° C. | 14-26% (SFC) | AOCS CD 16B-93 |
| 50° F. | 49-55 (SFI) | FATQC-502 |
| 70° F. | 42-48 (SFI) | FATQC-502 |
| 80° F. | 40-46 (SFI) | FATQC-502 |
| 92° F. | 32-36 (SFI) | FATQC-502 |
| 104° F. | 22-26 (SFI) | FATQC-502 |

An example of a suitable roll-in shortening is Pillsbury™ Specialty Shortening, from Golden Foods Golden Brands, LLC, Louisville, Ky., United States. Another type of roll-in shortening suitable for use is a low trans fat plastic shortening.

The dough used in the invention may be any conventional flour and water based dough. The flour may include one or more flours that can be made into an extensible dough, such as wheat flour, whole wheat flour, rice flour, artificial flour, gluten-free flour, and the like. Some doughs used in accordance with the invention, such as toaster pastry doughs, include a dough shortening, to be distinguished from the laminate fat described above. The dough shortening or lipid may be any of the conventional hydrogenated vegetable oil shortenings available on the market that are commonly employed in the baking industry. Examples include plastic or hydrogenated glyceride shortenings derived most commonly from vegetable oils by hydrogenation. The common oils are cottonseed oil, soybean oil, coconut oil, rapeseed oil, peanut oil, olive oil, palm oil, sunflower seed oil and the like, and blends thereof. The dough shortening may be low trans-fat, zero trans-fat, or trans-fat free, or a combination thereof. The dough shortening is blended with the flour and water when the dough is mixed, and becomes part of the substantially homogeneous dough mass. As used herein, the “dough shortening” is not visibly distinguishable from the rest of the dough after the dough ingredients have been mixed together. In one example of a toaster pastry dough, dough shortening is included in an amount ranging from about 0.5% to about 10% by weight of the dough, or from about 1% to about 5% by weight, or from about 1% to about 2% by weight. In general, dough shortening is present in an amount ranging from about 1% to about 7% by weight of the dough. The dough shortening may have different physical characteristics from the laminate fat. For example, the dough shortening may have a melting point that is lower than the melting point of the laminate fat. An example of a suitable dough shortening is SanTrans™ Cakemix shortening, from Loders Croklaan, Channahon, Ill., United States. The dough may include laminate fat, or a combination of laminate fat and dough shortening. However, upon mixing the dough ingredients, the laminate fat does not form discrete layers in the mixed dough.

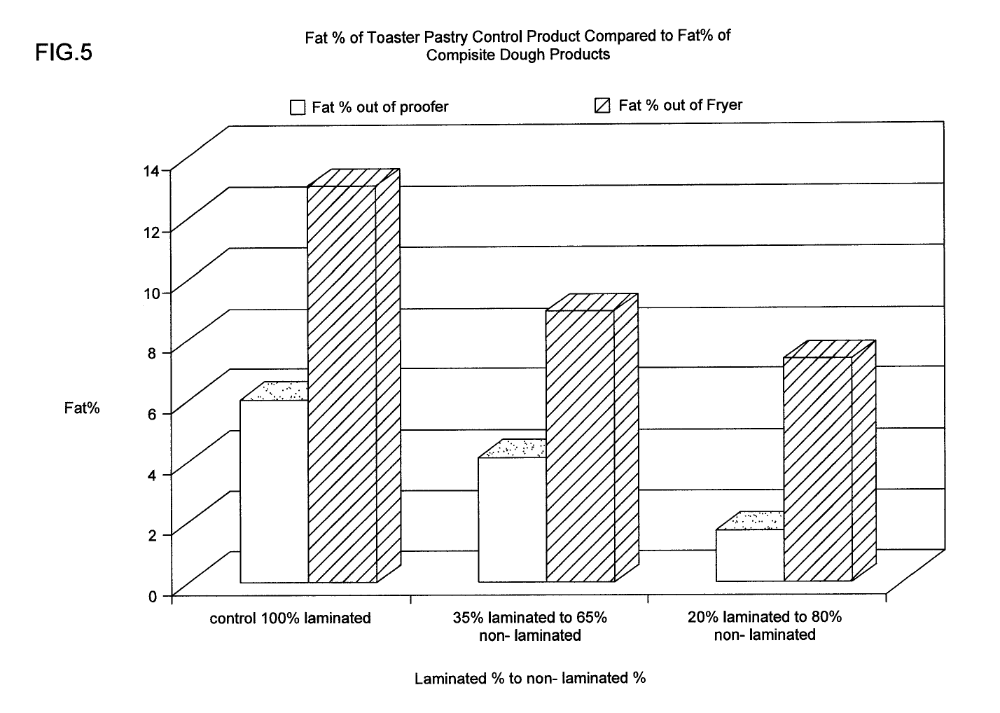

Products made in accordance with the invention may have a significantly lower fat content than corresponding products made from a fully laminated dough. FIG. 5 is a bar graph showing the percentages of fat in toaster pastry products by weight of the toaster pastry products, both before and after the frying of the products. In this graph, the percent fat content of a control, fully laminated toaster pastry product is compared to the percent fat content of the following two composite dough products: a toaster pastry product with a ratio of laminated dough component thickness to non-laminated dough component thickness of 35:65, hereinafter, the “35:65 product”, and a toaster pastry product with a ratio of laminated dough component thickness to non-laminated dough component thickness of 20:80, hereinafter, the “20:80 product”. The percent fat content of the control product, prior to frying, was approximately 6% by weight, while for the 35:65 product, the percent fat content was approximately 4.1% by weight. For the 20:80 product, the percent fat content, prior to frying, was approximately 1.7% by weight. Therefore, prior to frying, there was approximately a 32% decrease in percent fat content from the control product to the 35:65 product, and approximately a 72% decrease in percent fat content from the control product to the 20:80 product. After frying, the percent fat content of the control product was approximately 13% by weight, the percent fat content in the 35:65 product was approximately 8.9% by weight, and the percent fat content in the 20:80 product was approximately 7.3% by weight. Therefore, after frying, there was approximately a 32% decrease in percent fat content from the control product to the 35:65 product, and approximately a 44% decrease in percent fat content from the control product to the 20:80 product. As illustrated by these results, the preparation of toaster pastry products in accordance with the invention can lead to a significant reduction in fat content.

As noted above, the composite dough product of the invention can be made by combining a laminated dough with a non-laminated dough, using commercially available equipment such as depositors, extruders, sheeters, and the like. Regardless of the process used, it is important to be able to retain the individual characteristics of each dough component in the finished dough product, as these characteristics produce the desired organoleptic properties in the cooked dough product.

Various cooked dough products may be prepared from composite dough products comprising one or more laminated components and one or more non-laminated components. Such cooked dough products may include, for example, Danish pastries, biscuits, rolls, croissants, puff pastry, sweet rolls, caramel rolls, medialunas, strudel, and the like.

The following Examples describe the preparation of a toaster pastry product made in accordance with the invention. The toaster pastry products of the invention include at least one laminated dough component and at least one non-laminated dough component. Although the following Examples describe the products and processes of the invention, they are not intended to limit the scope of the invention.

### Examples: Toaster Pastry Products

One example of a traditionally 100% laminated dough product is a toaster pastry. In one conventional toaster pastry, roll-in shortening is present in an amount of about 6.5% by weight of the dough product, and is divided into 16 discrete layers. These 16 layers provide the toaster pastry with the key pastry attributes of a crisp, flaky exterior and a tender, bready interior.

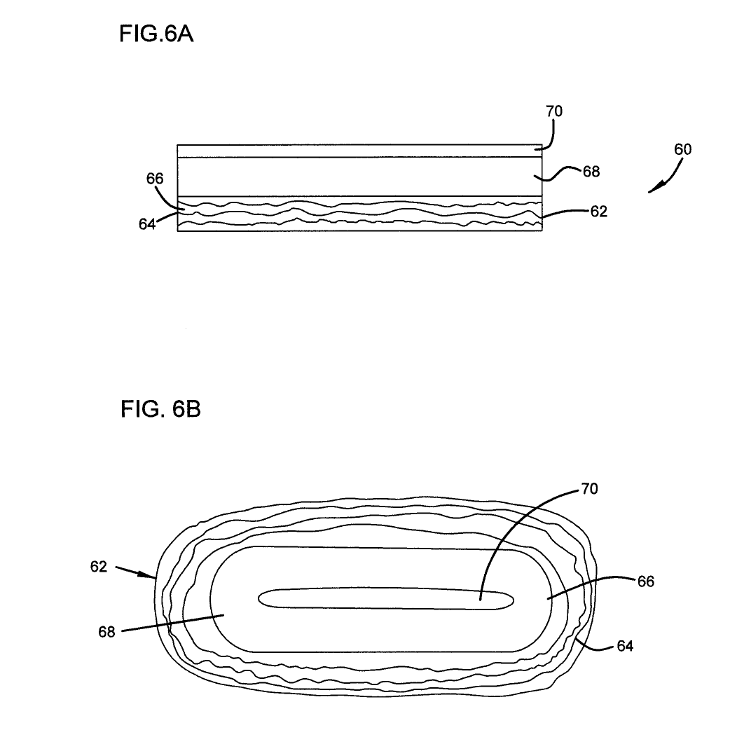

A process used to prepare toaster pastry products in accordance with the invention involves preparing a sheet of laminated dough 62 including fat layers 64 and dough layers 66, as depicted in FIG. 6a, and then laying a sheet of non-laminated dough 68 on top of the laminated sheet, to form a composite dough product 60. The composite dough product 60 is sheeted down to approximately 2 mm, to form a composite dough pad. A filling material 70 is then deposited on top of the 2 mm dough pad. A wide variety of filling compositions may be used in the invention, such as fruit fillings, spices, eggs, and meat. There is also no specific limitation on the flavors of the filling composition, which may include, for example, grape, strawberry, cinnamon, cherry, blueberry, and the like.

After the filling material is deposited, the dough pad is folded to encase the filling material, such that the laminated dough with multiple layers of roll-in shortening is positioned on the outside of the product, as shown in FIG. 6b. The product is then proofed. After proofing, the product is ready for cooking, such as by frying. After the product is cooked, the product may be frozen and packaged. Alternatively, the product may be frozen prior to proofing, or frozen prior to cooking, for subsequent proofing, if needed, and cooking by an end user.

In the following Examples, a variety of toaster pastries were prepared in accordance with the invention. The doughs used in the following examples were each prepared by mixing the ingredients of the formula set forth below in Table 2.

TABLE 2
Dough Formula

| | Amount of ingredient, as a |
|---|---|
| | percentage by weight of |
| Ingredient | the final dough mixture |
| Flour | 55-65% |
| Water | 27-37% |
| Leaveners | 1-4% |
| Emulsifiers | 1-4% |
| Sweeteners | 1-4% |
| Minor ingredients | 1-2% |

A first portion of dough was used to form a laminated dough pad. The dough was laminated with a roll-in shortening using conventional machinery during a sheeting step. After a dough product including one layer of roll-in shortening between two layers of dough was prepared, the dough product was folded and sheeted until a laminated dough pad with the desired number of layers of roll-in shortening was prepared.

After the laminated dough pad was formed, a second portion of dough was extruded onto the laminated dough pad, using a RyKaart™ three-roll extruder. This second portion of dough was non-laminated. The resulting composite dough product was sheeted down to a thickness of about 2.0 mm to form a composite dough pad.

As noted above, roll-in shortening was used to form the fat layers in the laminated dough components of the pastries. For each of the following Examples, the ratio of the thickness of the laminated dough component to the thickness of the non-laminated dough component, and the number of layers of roll-in shortening in the laminated dough component of the pastry, is provided in Table 3.

TABLE 3
Toaster Pastry Examples

| | Ratio of the Thickness of the | Number of Layers of |
|---|---|---|
| | Laminated Dough Component to the | Roll-in Shortening in |
| Example | Thickness of the Non-Laminated | Laminated Dough |
| Number | Dough Component | Component |
| 1 | 50:50 | 8 |
| 2 | 33:67 | 16 |
| 3 | 33:67 | 4 |
| 4 | 33:67 | 2 |
| 5 | 30:70 | 16 |
| 6 | 30:70 | 8 |
| 7 | 30:70 | 4 |
| 8 | 20:80 | 16 |
| 9 | 20:80 | 8 |
| 10 | 20:80 | 4 |
| 11 | 17:83 | 6 |

The laminated dough pad of the product of Example 1 included roll-in shortening at a ratio of 7%, while the laminated dough pads of the products of Examples 2-11 included roll-in shortening at a ratio of 10%. These ratios of roll-in shortening represent the weight of roll-in shortening in relation to the weight of the dough of the laminated dough component without roll-in shortening.

After the laminated dough pad was combined with a non-laminated dough component to make a composite dough pad, a filling material was deposited on top of the composite dough pad. The dough pad was then folded to encase the filling material, such that the laminated dough component with multiple layers of roll-in shortening was positioned on the outside of the product, and the non-laminated dough was positioned inside the product.

For a toaster pastry made in accordance with the invention, the weight of the dough of each toaster pastry may be in the range of about 30 grams to about 40 grams; for example, in the range of about 33 grams to about 39 grams. The weight of the filling may be in the range of about 9 grams to about 16 grams; for example, in the range of about 10.9 grams to about 15.1 grams. The total combined weight of the dough and the filling of each toaster pastry may be in the range of about 45 grams to about 53 grams; for example, in the range of about 45.9 grams to about 52.1 grams.

Uncooked toaster pastries made in accordance with the invention may be proofed at a temperature in the range of about 105° F. to about 115° F., at a percent relative humidity in the range of about 50% to about 60%, for an amount of time in the range of about 25 minutes to about 35 minutes. For example, the uncooked toaster pastries in Examples 1-11 were proofed at a percent relative humidity in the range of about 51% to about 59%, for an amount of time in the range of about 28 minutes to about 32 minutes. The uncooked toaster pastries may be fried for about 40 to about 45 seconds, in an oil at an oil temperature of about 350° F. to about 400° F. For example, many of the uncooked toaster pastries in Examples 1-11 were fried for about 41 to about 43 seconds, in an oil at an oil temperature of about 370° F. to about 374° F. The cooked toaster pastries may then be frozen to reach an equilibrated core temperature in the range of about −5° F. to about 5° F.

### Sensory Panel Results

Five types of toaster pastry products were evaluated by a trained sensory panel composed of six people. The doughs used for these five toaster pastry products were each prepared by mixing the ingredients of the formula set forth above in Table 2. For each of the five products, the ratio of the thickness of the laminated dough component to the thickness of the non-laminated dough component, and the number of layers of roll-in shortening in the pastry, is provided in Table 4.

TABLE 4
Products Evaluated by Sensory Panel

| | Ratio of the Thickness of the | |
|---|---|---|
| | Laminated Dough Component to the | |
| Product | Thickness of the Non-Laminated | Number of Layers |
| Number | Dough Component | of Roll-in Shortening |
| 1 | Control Product (100% Laminated | 16 |
| | Dough; No Non-Laminated Dough | |
| | Component) | |
| 2 | 30:70 | 16 |
| 3 | 20:80 | 16 |
| 4 | 20:80 | 8 |
| 5 | 20:80 | 4 |

Product 1, the control product, was made only from laminated dough. It did not include a non-laminated dough component. Specifically, Product 1 was made by preparing a sheet of laminated dough including 16 layers of roll-in shortening. The sheet of laminated dough was approximately 2 mm thick. A filling material was deposited on top of the sheet of laminated dough. After the filling material was deposited, the sheet of laminated dough was folded to encase the filling material. Product 1 was proofed, cooked, frozen, and re-heated in a toaster prior to evaluation by the sensory panel. The product included roll-in shortening at a ratio of 7%. The ratio of roll-in shortening in a fully laminated product, such as Product 1, is the weight of the roll-in shortening in relation to the weight of the dough without roll-in shortening.

Products 2-5 were composite dough products including both a laminated dough component and a non-laminated dough product. These products were made in accordance with the method used to prepare the toaster pastries of Examples 1-11, as described above. These toaster pastry products were each cooked, frozen, and re-heated in a toaster prior to evaluation by the sensory panel. The laminated dough pads of Products 2-5 each included roll-in shortening at a ratio of 10%, where the ratio of roll-in shortening represents the weight of roll-in shortening in relation to the weight of the dough of the laminated dough pad without roll-in shortening.

When asked which of the five products was the most similar to a fully laminated product identical to the control product, two people selected Product 3, two people selected Product 4, one person selected Product 5, and one person selected control Product 1.

Therefore, surprisingly, most of the sensory panel members selected composite dough products of the invention as being most similar to the fully laminated control product. These sensory panel results indicate that by strategically placing layers of fat in a composite dough product in accordance with this invention, a product which is organoleptically indistinguishable from and unexpectedly superior to a fully laminated product can be prepared.

Additional sensory data were generated to further investigate this unexpected discovery. Four types of toaster pastry products were evaluated by a trained sensory panel composed of three people. The doughs used for these four toaster pastry products were each prepared by mixing the ingredients of the formula set forth above in Table 2. For each of the four products, the number of layers of roll-in shortening in the pastry, the percentage of roll-in shortening, and the percent lamination in the product are provided in Table 5.

TABLE 5
Products Evaluated by Sensory Panel

| | | % of roll-in | % Laminated |
|---|---|---|---|
| Product | Number | shortening in | Dough by |
| Number | of Layers | the product | Thickness |
| 6 (Control) | 16 | 4.8 | 100 |
| 7 | 16 | 2.8 | 30 |
| 8 | 24 | 2.8 | 30 |
| 9 | 8 | 2.8 | 30 |

Product 6, the Control product, was made in the same manner as the Control Product 1 described above, but with roll-in shortening at a ratio of 5% instead of 7%.

Products 7-9 were composite dough products including both a laminated dough component and a non-laminated dough product. These products were made in accordance with the method used to prepare the toaster pastries of Examples 1-11, as described above. These toaster pastry products were each cooked, frozen, and re-heated in a toaster prior to evaluation by the sensory panel. The laminated dough pads of Products 7-9 each included roll-in shortening at a ratio of about 10% based on the weight of the roll-in shortening based on the weight of the dough of the laminated dough pad without roll-in shortening.

The trained sensory panel evaluated the products on crust flakiness, crispness and tenderness, on a scale of 1 to 9, with products scoring in the range of about 3-7 being acceptable, and products scoring in the range of about 4-6 being optimal. Any rating of about 5 to about 6 was considered to be equivalent to or an enhancement over the Control product. The sensory panel results are summarized in Table 6.

TABLE 6
Product Averages for Sensory Attributes

| | Product 6 | | | |
|---|---|---|---|---|
| Attribute | (Control) | Product 7 | Product 8 | Product 9 |
| Crust Flakiness | 5.0 | 5.0 | 5.0 | 5.5 |
| Crispness | 5.0 | 5.0 | 5.0 | 6.0 |
| Tenderness | 5.0 | 5.4 | 4.6 | 5.2 |

It was surprisingly observed that the trained sensory panel found no significant differences, and even some enhancements, between the Control Product and the composite dough products of the invention, even though the level of roll-in shortening used to make the composite dough products was almost 42% less than the amount of roll-in shortening in the Control Product. This is surprising because given the reduction of roll-in shortening, important product attributes were not adversely affected, and, in fact, stayed the same or were enhanced in the products made in accordance with this invention.

These equivalent or superior sensory panel results are unexpected due the fact that the fat content in the composite dough product was significantly reduced as compared to the control product, and yet the composite dough product had equivalent or superior qualities, such as flakiness, crispness, and tenderness, which are typically attributed to a higher fat content in a product. Prior to this invention, it was not believed that these qualities could be achieved or even surpassed by a product containing a reduced level of fat, and particularly not with a significantly reduced level of roll-in shortening.

Although the invention and its advantages have been described in detail, it should be understood that various changes, substitutions and alterations can be made herein without departing from the spirit and scope of the invention as defined by the appended claims. Moreover, the scope of the application is not intended to be limited to the particular embodiments of the invention described in the specification. As one of ordinary skill in the art will readily appreciate from the disclosure of the invention, the compositions, processes, methods, and steps, presently existing or later to be developed that perform substantially the same function or achieve substantially the same result as the corresponding embodiments described herein may be utilized according to the invention.

What is claimed is:

1. A composite dough product comprising:
a laminated dough component having a laminated dough component thickness, wherein the laminated dough component includes at least one laminate, said laminate comprising at least one layer of dough having a laminate dough layer thickness and at least one discrete layer of fat; and
a non-laminated dough component having a non-laminated dough component thickness, wherein the non-laminated dough component thickness is greater than the laminate dough layer thickness, and
wherein the laminated dough component and the non-laminated dough component each retain their individual characteristics in the composite dough product.

2. The composite dough product of claim 1, wherein the laminated dough component comprises a plurality of laminates, and the non-laminated dough component is a continuous dough matrix.

3. The composite dough product of claim 2, comprising from between about 2 to about 64 laminates.

4. The composite dough product of claim 2, comprising from between about 4 to about 36 laminates.

5. The composite dough product of claim 1, wherein the non-laminated dough component thickness is approximately equal to the laminated dough component thickness.

6. The composite dough product of claim 1, wherein the non-laminated dough component thickness is greater than the laminated dough component thickness by a ratio of non-laminated component thickness to laminated dough component thickness of about 80:20, about 70:30, about 65:35, or about 60:40.

7. The composite dough product of claim 1, wherein the laminated dough component thickness is greater than the non-laminated dough component thickness by a ratio of laminated component thickness to non-laminated dough component thickness of about 80:20, about 70:30, about 65:35, or about 60:40.

8. The composite dough product of claim 1, wherein the composite dough product has a percent fat content that is less than a percent fat content of a non-composite dough product consisting of a plurality of laminates, wherein the composite dough product and the non-composite dough product have at least substantially identical organoleptic properties.

9. The composite dough product of claim 8, wherein the percent fat content of the composite dough product is between about 32% to about 72% less than the percent fat content of the non-composite dough product

10. A pastry product comprising the composite dough product of claim 1, wherein a surface of the laminated dough component is an exterior surface of the pastry product.

11. A product comprising the composite dough product of claim 1, wherein a surface of the non-laminated dough component is an exterior surface of the product.

12. A pastry product comprising a cooked dough shell encasing an interior filling, wherein the cooked dough shell comprises the composite dough product of claim 1, said cooked dough shell having a flaky exterior surface, and at the same time a bready well developed interior cell structure, and wherein the interior filling is in contact with the non-laminated dough component.

13. A composite dough product comprising:
a laminated dough component having a laminated dough component weight, wherein the laminated dough component includes at least one laminate comprising at least one layer of dough having a laminate dough layer weight and at least one discrete layer of fat, and wherein the laminated dough component weight comprises a total weight of layers of fat and a total weight of laminate dough layers; and,
a non-laminated dough component having a non-laminated dough component weight, wherein the non-laminated dough component weight is greater than the laminate dough layer weight of one laminate, and
wherein the laminated dough component and the non-laminated dough component each retain their individual characteristics in the composite dough product.

14. The composite dough product of claim 13, wherein the laminated dough component comprises a plurality of laminates, and the non-laminated dough component is a continuous dough matrix.

15. The composite dough product of claim 14, comprising from between about 2 to about 64 laminates.

16. The composite dough product of claim 14, comprising from between about 4 to about 36 laminates.

17. The composite dough product of claim 13, wherein the non-laminated dough component weight is approximately equal to the laminated dough component weight.

18. The composite dough product of claim 13, wherein the non-laminated dough component weight is greater than the total weight of laminate dough layers by a ratio of non-laminated dough component weight to laminated dough component weight of about 80:20, about 70:30, about 65:35 or about 60:40.

19. The composite dough product of claim 13, wherein the total weight of laminate dough layers is greater than the non-laminated dough component weight by a ratio of laminated dough layer component weight to non-laminated dough component weight of about 80:20, about 70:30, about 63:35 or about 60:40.

20. The composite dough product of claim 13, wherein the composite dough product has a percent fat content that is less than a percent fat content of a non-composite dough product consisting of a plurality of laminates, wherein the composite dough product and the non-composite dough product have at least substantially identical organoleptic properties.

21. The composite dough product of claim 20, wherein the percent fat content of the composite dough product is between about 32% to about 72% less than the percent fat content of the non-composite dough product

22. A pastry product comprising the composite dough product of claim 13, wherein a surface of the non-laminated dough component is an exterior surface of the pastry product.

23. A pastry product comprising the composite dough product of claim 13, wherein a surface of the laminated dough component is an exterior surface of the pastry product.

24. A pastry product comprising a cooked dough shell encasing an interior filling, wherein the cooked dough shell comprises the composite dough product of claim 13, said cooked dough shell having a flaky exterior surface, and at the same time a bready well developed interior cell structure, and wherein the interior filling is in contact with the non-laminated dough component.

25. A pastry product comprising:
a dough shell encasing an interior filling, wherein the dough shell comprises a laminated dough component having a laminated dough component thickness and a non-laminated dough component having a non-laminated dough component thickness,
wherein the laminated dough component includes at least one laminate comprising at least one layer of dough having a laminate dough layer thickness and at least one layer of roll-in shortening, and
wherein the non-laminated dough component thickness is greater than the laminate dough layer thickness, and
wherein the laminated dough component and the non-laminated dough component each retain their individual characteristics in the pastry product.

26. A method of making a pastry product, comprising:
providing a dough;
laminating a first portion of the dough and a fat to form a laminated dough pad comprising at least one layer of dough having a laminate dough layer weight and at least one layer of fat; and,
providing a second portion of the dough onto the laminated dough pad, wherein the weight of the second portion of the dough is greater than the laminate dough layer weight, to form a composite dough product.

27. The method of claim 26, further comprising:
sheeting the composite dough product to make a composite dough pad.

28. The method of claim 26, further comprising:
depositing a filling material onto the composite dough pad, so that the filling material is in contact with the second portion of the dough; and,
folding the composite dough pad so that the filling material is encased by the composite dough pad.
